(19) United States
(12) Patent Application Publication
(10) Pub. No.: US 2025/0171987 A1
(43) Pub. Date: May 29, 2025

(54) FAUCET LOCKING MECHANISM, FAUCET ASSEMBLY AND FAUCET MOUNTING STRUCTURE

(71) Applicant: Beijing Kohler Ltd., Beijing (CN)

(72) Inventor: Jiagao HUANG, Beijing (CN)

(73) Assignee: Beijing Kohler Ltd., Beijing (CN)

(21) Appl. No.: 18/952,206

(22) Filed: Nov. 19, 2024

(30) Foreign Application Priority Data
Nov. 23, 2023 (CN) 202323176382.7

(51) Int. Cl. E03C 1/04; F16B 35/00

(52) U.S. Cl. CPC E03C 1/0401; F16B 35/005

(57) ABSTRACT

A faucet locking mechanism, a faucet assembly and a faucet mounting structure comprising a connecting sleeve, a locking sleeve, a sliding frame and a screw element; wherein the locking sleeve is provided with a plurality of flexible retainers arranged around the connecting sleeve at intervals, and the sliding frame is slidably assembled around the plurality of the flexible retainers; the screw element passes through the sliding frame and the locking sleeve and is capable of driving the sliding frame to press and separate from the flexible retainers; retainer ends of the plurality of flexible retainers are locked with the connecting sleeve respectively when the sliding frame presses the flexible retainers.

### CROSS REFERENCE TO RELATED APPLICATIONS

This application claims the benefit of and priority to Chinese Patent Application No. 202323176382.7, filed on Nov. 23, 2023, the entire disclosure of which is hereby incorporated by reference herein.

### BACKGROUND

The present application relates to the technical field of mounting a basin faucet, and in particularly relates to a faucet locking mechanism, a faucet assembly, and a faucet mounting structure.

In kitchens, bathrooms, balconies, and other places, faucets on washbasins, hand basins, vegetable basins, and other basins are mostly mounted with nuts. For example, an inlet pipe or a sleeve pipe of the faucet passes through a through hole of the basin, the nut is connected, by thread, with the inlet pipe or the sleeve pipe and at a bottom of the basin, and the faucet is locked by tightening the nut. Generally, a diameter of an inlet pipe or a sleeve pipe is large, which requires a nut with large diameter, and a nut with a relatively large size requires a great torque, and a large wrench is needed to tighten the nut when tightening or removing the nut. The mounting space under some basins or bathroom cabinets is narrow and not suitable for wrenching with a large-sized wrench, which makes it very troublesome to lock and remove the nuts. The operation is time-consuming and laborious with low mounting efficiency.

### SUMMARY

At least one aspect of the present disclosure relates to a faucet locking mechanism. The faucet locking mechanism includes a connecting sleeve, a locking sleeve sleeved on the connecting sleeve, a sliding frame slidably mounted in the locking sleeve, and a screw element threaded-connected with the sliding frame and used for driving the sliding frame to slide up and down. The locking sleeve includes a plurality of flexible retainers arranged around the connecting sleeve at intervals, and the sliding frame is slidably assembled around the plurality of the flexible retainers. The screw element passes through the sliding frame and the locking sleeve and is configured to drive the sliding frame to engage with and separate from the flexible retainers. When the sliding frame presses the flexible retainers, the retainer ends of the plurality of flexible retainers are locked with the connecting sleeve, respectively.

In various embodiments, the connecting sleeve is provided with a plurality of sleeve recesses at intervals along an axial direction, and the retainer ends of the flexible retainers are selectively locked in one of the sleeve recesses. In various embodiments, retainer protrusions are provided at one side of the flexible retainers faced the sliding frame, and the retainer ends lock the connecting sleeve when the sliding frame presses the retainer protrusions. In various embodiments, the surfaces of the retainer protrusions face a side at which the sliding frame locates are protrusion slopes, and the distances between the protrusion slopes and the connecting sleeve gradually increase along a direction of up-to-down.

In various embodiments, a surface of the sliding frame faced a side at which the retainer protrusions locate has a sliding frame slope adapted with the protrusion slopes. When the sliding frame presses the retainer protrusions, the sliding frame slope attaches to and presses the protrusion slopes.

In various embodiments, a spring is provided within the locking sleeve, the spring surrounds the sliding frame and contacts the sliding frame. In various embodiments, the flexible retainers are integrally formed with the locking sleeve.

At least one aspect of the present disclosure relates to a faucet assembly. The faucet assembly includes a faucet body and the faucet locking mechanism according to any one of the preceding embodiments. An upper end of the connecting sleeve is connected to the faucet body, and the locking sleeve is positioned below the faucet body.

At least one aspect of the present disclosure relates to a faucet mounting structure. The faucet mounting structure includes a mounting platform and the faucet assembly according to the preceding embodiments. The mounting platform has a platform through hole, and a bottom surface of the mounting platform is provided with a rigid gasket ring. The faucet body is located above the mounting platform. The connecting sleeve passes through the platform through hole and the rigid gasket ring. The rigid gasket ring is located above the locking sleeve and an upper end of the screw element is connected to the rigid gasket ring. The plurality of flexible retainers clamps the connecting sleeve, the faucet body and the rigid gasket ring are clamped and secured to the mounting platform, respectively. In various embodiments, a flexible spacer ring is provided between a bottom surface of the mounting platform and the rigid gasket ring.

When assembling, firstly, the connecting sleeve is assembled with the faucet body. Then the connecting sleeve passes through a platform through hole of the mounting platform. The locking sleeve, the sliding frame and the screw element are assembled and sleeved on the connecting sleeve, and then the locking sleeve is moved upwardly until an upper end of the screw element lifts the mounting platform or a rigid gasket ring below the mounting platform. The screw element is rotated by a tool. The screw element drives the sliding frame to move downwardly and to press the elastic retainer, so that retainer ends of the flexible retainers are locked with the connecting sleeve to realize the fixation. When disassembling, the screw element is rotated in a reverse direction to drive the sliding frame upwardly and away from the flexible retainers. The retainer ends of the flexible retainers no longer tightly grip the connecting sleeve. Then the disassembly operation can be carried out.

With the faucet locking mechanism, the faucet assembly and the faucet mounting structure provided by the present application, only a tool with a small size such as a screwdriver or an opener is needed by a user to rotate the screw element, which results in less space and less torque needed during disassembly and assembly. It is convenient for users to disassemble and assemble, and the efficiencies of the disassembly and the assembly are improved. The faucet locking mechanism, the faucet assembly, and the faucet mounting structure can be easily and quickly disassembled and assembled.

### BRIEF DESCRIPTION OF THE DRAWINGS

With reference to the drawings, the contents disclosed by the present application will be more easily understood. It should be understood that: these drawings are merely used for illustration and are not intended to limit the protection scope of the present application. In the drawings:

FIG. 1 is a perspective view of a faucet locking mechanism provided by an embodiment of the present application;

FIG. 2 is an exploded view of the faucet locking mechanism shown in FIG. 1;

FIG. 3 is a perspective view of a locking sleeve at a top angle;

FIG. 4 is a perspective view of the locking sleeve at a bottom angle;

FIG. 5 is a sectional view of the locking sleeve;

FIG. 6 is a perspective view of a sliding frame; FIG. 7 is a sectional view of the sliding frame;

FIG. 8 is a sectional view of the faucet locking mechanism, wherein the sliding frame and the flexible retainers are in a separated state;

FIG. 9 is a sectional view of the faucet locking mechanism, wherein the sliding frame and the elastic retainer are in an engaged state;

FIG. 10 is an exploded view of the faucet assembly provided by an embodiment of the present application;

FIG. 11 is a perspective view of a faucet mounting structure provided by an embodiment of the present application;

FIG. 12 is a sectional view of the faucet mounting structure, wherein the sliding frame and the flexible retainers are in a separated state;

FIG. 13 is a sectional view of the faucet mounting structure, wherein the sliding frame and the flexible retainers are in an engaged state.

### DETAILED DESCRIPTION

The specific embodiments of the present application will be further described with reference to the drawings hereinafter. Same parts are denoted by the same reference signs. It should be noted that the terms “front”, “rear”, “left”, “right”, “up” and “down” used in the following description refer to the directions in the drawings, and the terms “inner” and “outer” refer to the directions toward or away from the geometric centers of specific parts, respectively.

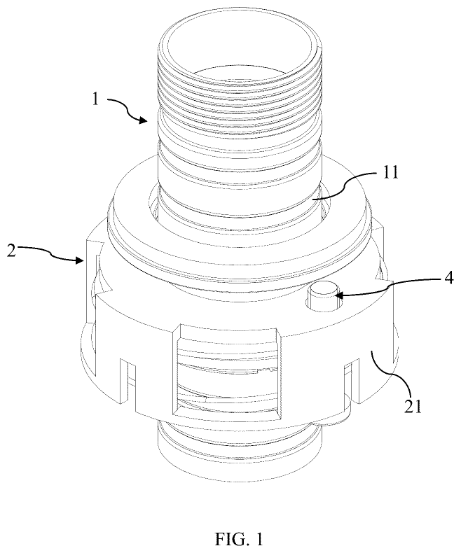

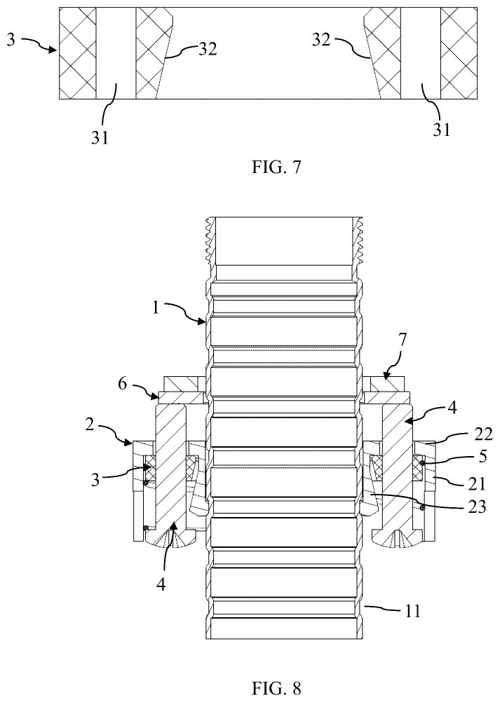

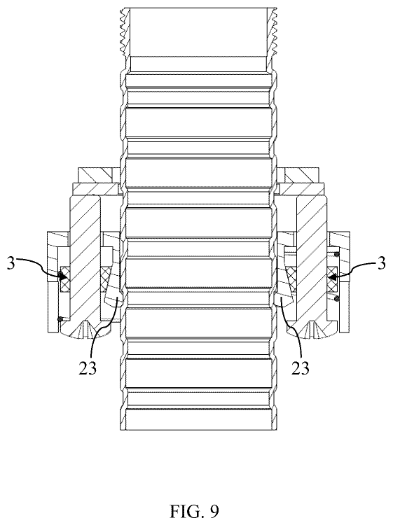

As shown in FIGS. 1-9, a faucet locking mechanism provided by an embodiment of the present application includes a connecting sleeve 1, a locking sleeve 2 sleeved on the connecting sleeve 1, a sliding frame 3 slidably mounted in the locking sleeve 2, and a screw element 4 connected, by thread, with the sliding frame 3 and used for driving the sliding frame 3 to slide up and down.

The locking sleeve 2 includes a plurality of flexible retainers 23 arranged around the connecting sleeve 1 at intervals, and the sliding frame 3 is assembled, for example, by sliding, around the plurality of flexible retainers 23. The screw element 4 passes through the sliding frame 3 and the locking sleeve 2 and is configured to allow the sliding frame 3 to be removably coupled from (e.g., engage with and separate from) the flexible retainers 23. The locking sleeve 2 includes screw openings 222, in which the screw element 4 passes through. When the sliding frame 3 engages with the flexible retainers 23, the retainer ends 231 of the plurality of flexible retainers 23 are locked with the connecting sleeve 1, respectively.

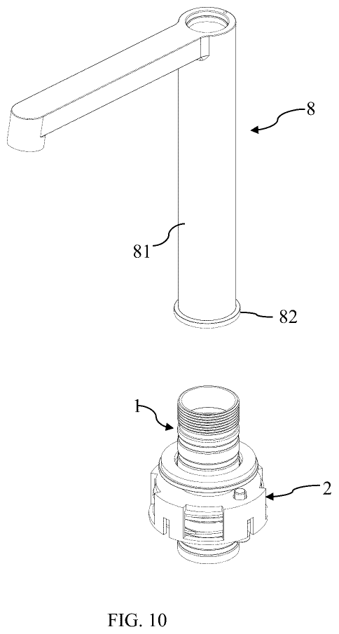

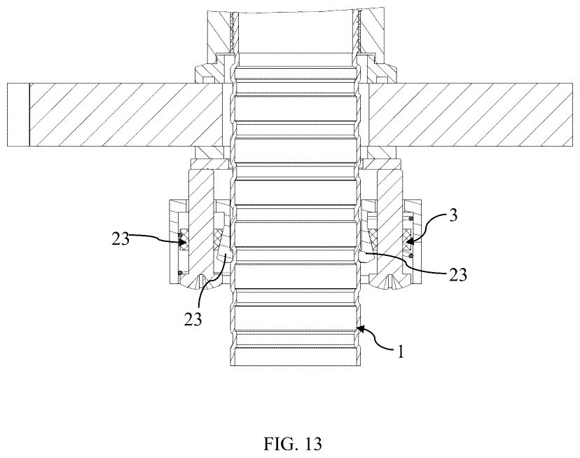

A faucet locking mechanism provided by the present application is used for locking the faucet body 8 shown in FIGS. 10-13 to a mounting platform 9. The faucet locking mechanism includes a connecting sleeve 1, a locking sleeve 2, a sliding frame 3 and a screw element 4. The upper end of the connecting sleeve 1 is used for the connection of the faucet body 8. Specifically, the upper end of the connecting sleeve 1 is provided with an external thread, which is connected, by the external thread, to the standing pipe 81 of the faucet body 8. The lower end of the standing pipe 81 has a mounting base 82 for clamping on the top surface of the mounting platform 9.

The locking sleeve 2 is sleeved onto the connecting sleeve 1 and configured to secure the connecting sleeve 1. A plurality of the flexible retainers 23 are arranged at intervals in the locking sleeve 2 along a circumferential direction of its center hole. The lower ends of the flexible retainers 23 have retainer ends 231 projecting towards the connecting sleeve 1 for locking the connecting sleeve 1.

In some embodiments, the sliding frame 3 is a circular shape and is sleeved around the flexible retainers 23 and capable of sliding along the length (e.g., up and down) of the locking sleeve 2. When the sliding frame 3 is in a high position, referred to as an initial position, in the locking sleeve 2, the sliding frame 3 is separated from the flexible retainers 23 and does not press the flexible retainers 23. In the initial position, the retainer ends 231 of the flexible retainers 23 and the connecting sleeve 1 are in a relaxed state. When the sliding frame 3 is in a low position, referred to as an engaged position, in the locking sleeve 2, the sliding frame 3 presses the flexible retainers 23, causing the retainer ends 231 of the flexible retainers 23 to move toward a side at which the connecting sleeve 1 is positioned, such that the flexible retainers 23 lock with the connecting sleeve 1.

In some embodiments, the screw element 4 is a screw or a bolt. The sliding frame 3 may be switched between the above-described initial position and the engaged position by rotating the screw element 4. For example, the sliding frame 3 is provided with an internal threaded hole 31. The screw element 4 passes through and is connected by thread with the internal threaded hole 31. When mounting, the upper end of the screw element 4 lifts the mounting platform 9 or the rigid gasket ring 6 below the mounting platform 9. Thus, when being rotated, the screw element 4 does not move in a straight line, and the sliding frame 3 is driven to move up and down due to the action of the thread. In some embodiments, two screw elements 4 can be provided and arranged symmetrically on the sliding frame 3.

When assembling, first, the connecting sleeve 1 is assembled with the faucet body 8. Then, the connecting sleeve 1 passes through a platform through hole 91 of the mounting platform 9. The locking sleeve 2, the sliding frame 3 and the screw elements 4 are assembled and sleeved on the connecting sleeve 1. The locking sleeve 2 is moved upwards until upper ends of the screw elements 4 lift the mounting platform 9 or the rigid gasket ring 6. The screw elements 4 are rotated by a tool (e.g., a screwdriver, an opener, etc.). The screw elements 4 allow the sliding frame 3 to move downwards and press the flexible retainers 23, so that the retainer ends 231 of the flexible retainers 23 are locked with the connecting sleeve 1, resulting in fixation. When disassembling, the screw elements 4 are rotated reversely to drive the sliding frame 3 to move upwards and away from the flexible retainers 23. The retainer ends 231 of the flexible retainers 23 no longer tightly couple the connecting sleeve 1. Then, the disassembly operation can be carried out.

For the faucet locking mechanism provided by the present application, only a tool with a small size such as a screwdriver or an opener is needed for a user to rotate the screw elements 4. This results in less space and less torque needed during disassembling and assembling. It is convenient for users to disassemble and assemble, and the deficiencies of other disassembly and assembly processes are improved.

In various embodiments, an auxiliary locking structure facilitating the cooperation and the locking with the retainer ends 231 is included on the surface of the connecting sleeve 1 if needed. The auxiliary locking structure may be a rough surface, a thread, interlocked teeth, a recess, or a slot provided on an outer circumference of the connecting sleeve 1, to facilitate cooperation and locking with the retainer ends 231.

In some embodiments, the flexible retainers 23 and/or the sliding frame 3 is included with protrusions for forcing the flexible retainers 23 to deform. This configuration causes the retainer ends 231 to move toward the side at which the connecting sleeve 1 is positioned and ensures locking.

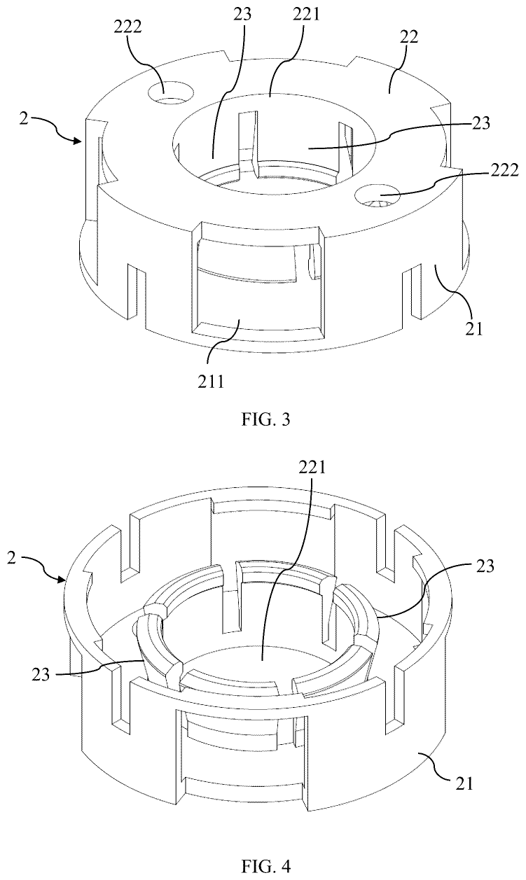

In some embodiments, as shown in FIGS. 3-5, the locking sleeve 2 is substantially in a sleeve shape and includes a sleeve body 21 and a top cover 22. The top cover 22 is connected to an upper end of the sleeve body 21. A central hole 221 is provided on the top cover 22 for the connecting sleeve 1 to pass through. The plurality of flexible retainers 23 is connected to the bottom surface of the top cover 22 and arranged around the central hole 221 at intervals. The sliding frame 3 is between the flexible retainers 23 and the sleeve body 21. The flexible retainers 23, the top cover 22, and the sleeve body 21 are formed integrally to provide high structural strength.

In some configurations, the sleeve body 21 includes notches 211 to allow a user to observe the position of the sliding frame 3 inside.

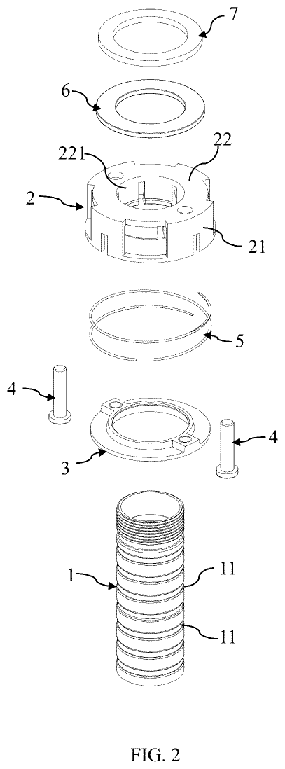

In some embodiments, as shown in FIG. 2 and FIGS. 8 and 9, a plurality of sleeve recesses 11 is provided on the connecting sleeve 1 at intervals along an axial direction, and the retainer ends 231 of the flexible retainers 23 are selectively coupled (e.g., locked) to one of the sleeve recesses 11. In these embodiments, a circumferential surface of the connecting sleeve 1 is configured with an auxiliary locking structure, which comprises the plurality of sleeve recesses 11 arranged at intervals in an up-and-down direction along the axial direction of the connecting sleeve 1.

When assembling, after the locking sleeve 2 is moved upwards (e.g., along the axial direction of the connecting sleeve 1) in place, the retainer ends 231 of the flexible retainers 23 are in one of the sleeve recesses 11. When the flexible retainers 23 are secured (for example, pressed) by the sliding frame 3, the retainer ends 231 are locked in the sleeve recesses 11, which makes the connection structure more stable.

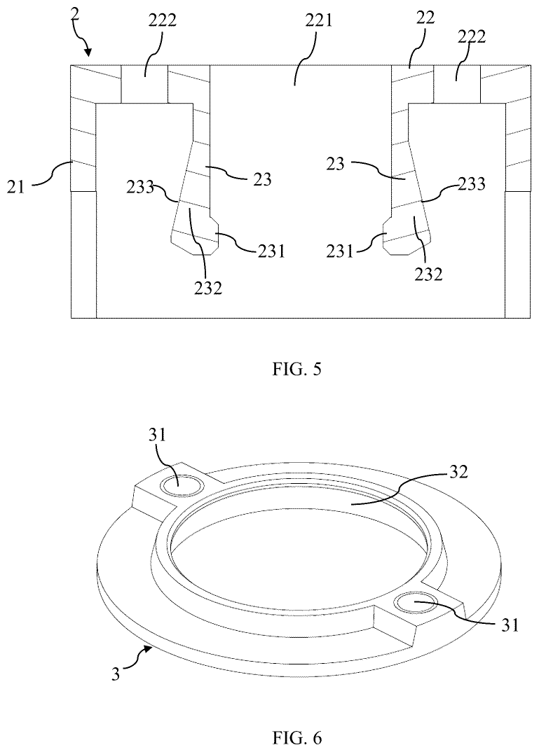

In some embodiments, as shown in FIG. 5 and FIGS. 8 and 9, retainer protrusions 232 are provided at one side of the flexible retainers 23 toward the sliding frame 3. When the sliding frame 3 presses the retainer protrusions 232, the retainer ends 231 lock with the connecting sleeve 1. In these embodiments, the retainer protrusions 232 are provided on outer surfaces of the flexible retainers 23 (a surface toward a side at which the sliding frame 3 is positioned), so that the retainer protrusions 232 are secured by the sliding frame 3 and forced to deform toward the side at which the connecting sleeve 1 locates, such that the retainer ends 231 are locked with the connecting sleeve 1.

In some embodiments, as shown in FIG. 5 and FIGS. 8 to 9, the retainer protrusions 232 have protrusion slopes 233. Protrusion slopes 233 are positioned on surfaces of the retainer protrusions 232 toward the side at which the sliding frame 3 is positioned. The distances between the protrusion slopes 233 and the connecting sleeve 1 gradually increase along a direction of up-to-down towards the top cover 22. Such an arrangement allows the sliding frame 3 to move downwardly to press the protrusion slopes 233, forcing the flexible retainers 23 to deform toward the side at which the connecting sleeve 1 is positioned, such that the retainer ends 231 are locked with the connecting sleeve 1.

In some embodiments, as shown in FIG. 5 and FIGS. 7 to 9, a surface of the sliding frame 3 towards a side at which the retainer protrusions 232 is positioned has a sliding frame slope 32 adapted with the protrusion slopes 233, i.e., they are inclined in a similar configuration. When the sliding frame 3 presses the retainer protrusions 232, the sliding frame slope 32 attaches and presses the protrusion slopes 233.

When the sliding frame 3 presses the retainer protrusions 232, the sliding frame slope 32 attaches and presses the protrusion slopes 233, which results in a more stable way of securing (e.g., pressing), and is more advantageous for forcing the flexible retainers 23 to deform toward the side at which the connecting sleeve 1 is positioned.

In some embodiments, as shown in FIG. 2 and FIGS. 8 to 9, a spring 5 is mounted in the locking sleeve 2. The spring 5 surrounds the sliding frame 3 and contacts the sliding frame 3, which helps to centralize the sliding frame 3, i.e., the sliding frame 3 is concentrically arranged with the connecting sleeve 1 to reduce offset.

In some embodiments, the flexible retainers 23 are formed integrally with the locking sleeve 2, and both the flexible retainers 23 and the locking sleeve 2 are plastic parts, which can be molded by one-piece injection molding, facilitating the processing and the molding, and resulting in high structural strength.

As shown in FIG. 10, a faucet assembly provided by an embodiment of the present application includes a faucet body 8 and a faucet locking mechanism according to any one of the preceding embodiments. An upper end of the connecting sleeve 1 is connected in the faucet body 8, and the locking sleeve 2 is below the faucet body 8.

The faucet assembly provided by the present application includes a faucet body 8 and a faucet locking mechanism. With respect to the structure, the construction, and the working principle of the faucet locking mechanism, please refer to the previous descriptions related to the faucet locking mechanism, and it will not be repeated here.

The faucet body 8 has a standing pipe 81 extending downwardly, wherein the lower end of the standing pipe 81 has a mounting base 82 for clamping on the top surface of the mounting platform 9. An internal thread is provided within the standing pipe 81 and an upper end of the connecting sleeve 1 has an external thread. The upper end of the connecting sleeve 1 is connected by thread in the standing pipe 81.

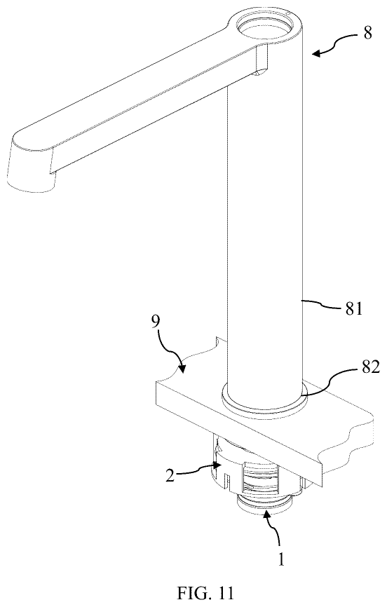

As shown in FIGS. 11 to 13, a faucet mounting structure provided by an embodiment of the present application comprises a mounting platform 9 and a faucet assembly according to any one of the preceding embodiments.

The mounting platform 9 has a platform through hole 91, and a bottom surface of the mounting platform 9 includes a rigid gasket ring 6. The faucet body 8 is located above the mounting platform 9 and the connecting sleeve 1 passes through the platform through hole 91 and the rigid gasket ring 6. The rigid gasket ring 6 is located above the locking sleeve 2 and an upper end of the screw element 4 is connected with the rigid gasket ring 6. A plurality of the flexible retainers 23 clamps the connecting sleeve 1. The faucet body 8 and the rigid gasket ring 6 are clamped and secured to the mounting platform 9, respectively.

The faucet mounting structure provided by the present application comprises a mounting platform 9 and a faucet assembly according to any one of the preceding embodiments.

The mounting platform 9 is a platform mounting portion of the basin and has a platform through hole 91 for the connecting sleeve 1 to pass through. The bottom surface of the mounting platform 9 has a rigid gasket ring 6, which may be a metal gasket ring for blocking the upper end of the screw element 4 and avoiding the abrasion caused by the upper end of the screw element 4 directly touching the mounting platform 9.

When assembling, first, the connecting sleeve 1 is assembled with the faucet body 8. Then the connecting sleeve 1 passes through the platform through hole 91 of the mounting platform 9. The locking sleeve 2, the sliding frame 3 and the screw element 4 are assembled and sleeved on the connecting sleeve 1. The locking sleeve 2 is moved upwards until an upper end of the screw element 4 lifts the mounting platform 9 or the rigid gasket ring 6 below the mounting platform 9. The screw element 4 is rotated by a tool and drives the sliding frame 3 to move downwards and presses the flexible retainers 23, so that the retainer ends 231 of the flexible retainers 23 are locked with the connecting sleeve 1, resulting in fixation. When disassembling, the screw element 4 is rotated in a reverse direction to drive the sliding frame 3 to move upwards and away from the flexible retainers 23. The retainer ends 231 of the flexible retainers 23 no longer tightly couples the connecting sleeve 1. Then the disassembly can be carried out.

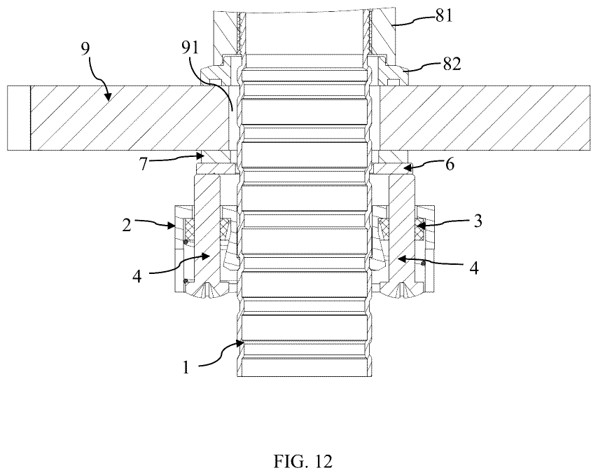

In one of the embodiments, as shown in FIG. 12, a flexible gasket ring 7 is positioned between the bottom surface of the mounting platform 9 and the rigid gasket ring 6. The flexible gasket ring 7 may be a rubber gasket ring that serves to protect the mounting platform 9.

The above technical solutions may be combined as required to achieve the best technical effect. The above are merely the principle and the preferred embodiments of the present application. It should be pointed out that for those of ordinary skills in the art, several other variations may be made on the basis of the principle of the present application, which should also be regarded as falling in the protection scope of the present application.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members, or the two members and any additional intermediate members being integrally formed as a single unitary body with one another or with the two members or the two members and any additional intermediate members being attached to one another. For example, such joining may be achieved with clamps, pressing pins, etc.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the assembly as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements maybe reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Other substitutions, modifications, changes, and omissions may also be made in the design, operating conditions, and arrangement of the various exemplary embodiments without departing from the scope of the present invention. For example, any element disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes, and omissions may be made in the design, operating configuration, and arrangement of the preferred and other exemplary embodiments without departing from the scope of the appended claims.

What is claimed is:

1. A faucet locking mechanism, comprising:
a connecting sleeve;
a locking sleeve sleeved on the connecting sleeve, and comprising a plurality of flexible retainers arranged around the connecting sleeve at intervals;
a sliding frame slidably mounted in the locking sleeve, positioned around the flexible retainers; and
a screw element connected, by thread, with the sliding frame and configured to drive the sliding frame to slide up and down along the connecting sleeve, the screw element passing through the sliding frame and the locking sleeve and configured to allow the sliding frame to be removable coupled to the flexible retainers.

2. The faucet locking mechanism of claim 1, wherein the flexible retainers comprise retainer ends that are locked with the connecting sleeve when the sliding frame presses the flexible retainers.

3. The faucet locking mechanism of claim 2, wherein the connecting sleeve comprises a plurality of sleeve recesses at intervals along an axial direction, and the retainer ends are selectively coupled to one of the sleeve recesses.

4. The faucet locking mechanism of claim 3, wherein:
the flexible retainers comprise retainer protrusions, the retainer protrusions positioned on a side of the flexible retainers, the side facing the sliding frame; and
the retainer ends lock the connecting sleeve when the sliding frame presses the retainer protrusions.

5. The faucet locking mechanism of claim 4, wherein the retainer protrusions comprise protrusion slopes, the protrusion slopes positioned on surfaces of the retainer protrusions that face a side at which the sliding frame is positioned, distances between the protrusion slopes and the connecting sleeve gradually increase along a direction of up-to-down.

6. The faucet locking mechanism according to claim 5, wherein:
the sliding frame comprises a sliding frame slope, the sliding frame slope on a surface of the sliding frame that faces a side of the retainer protrusions; and
when the sliding frame presses the retainer protrusions, the sliding frame slopes attaches with and presses the protrusion slopes.

7. The faucet locking mechanism of claim 1, wherein a spring is mounted within the locking sleeve, and the spring surrounds the sliding frame and interacts with the sliding frame.

8. The faucet locking mechanism of claim 1, wherein the flexible retainers are integrally formed with the locking sleeve.

9. A faucet assembly comprising:
a faucet body; and
the faucet locking mechanism of claim 1, an upper end of the connecting sleeve connected to the faucet body, and the locking sleeve is positioned below the faucet body.

10. A faucet mounting structure comprising:
a mounting platform comprising:
a platform through hole, and
a bottom surface comprising a rigid gasket ring; and
the faucet assembly of claim 9, the faucet body positioned above the mounting platform.

11. The faucet mounting structure of claim 10 wherein:
the connecting sleeve passes through the platform through hole and the rigid gasket ring;
the rigid gasket ring is positioned above the locking sleeve;
an upper end of the screw element is coupled to the rigid gasket ring;
the plurality of flexible retainers clamp the connecting sleeve; and
the faucet body and the rigid gasket ring are clamped and secured to the mounting platform.

12. The faucet mounting structure of claim 11 further comprising a flexible gasket ring positioned between a bottom surface of the mounting platform and the rigid gasket ring.

13. A faucet locking mechanism, comprising:
a connecting sleeve;
a locking sleeve sleeved on the connecting sleeve, and comprising a plurality of flexible retainers arranged around the connecting sleeve at intervals, the flexible retainers comprising retainer ends;
a sliding frame slidably mounted in the locking sleeve, positioned around the flexible retainers, the sliding frame configured to secure the retainer ends with the connecting sleeve when pressing the flexible retainers; and
a screw element connected with the sliding frame, the screw element passing through the sliding frame and the locking sleeve, and configured to allow the sliding frame to slide up and down and to be removable coupled to the flexible retainers.

14. The faucet locking mechanism of claim 13, wherein the connecting sleeve comprises a plurality of sleeve recesses at intervals along an axial direction, and the retainer ends are selectively coupled to one of the sleeve recesses.

15. The faucet locking mechanism of claim 13, wherein:
the flexible retainers comprise retainer protrusions, the retainer protrusions positioned on a side of the flexible retainers, the side facing the sliding frame; and
the retainer ends lock the connecting sleeve when the sliding frame presses the retainer protrusions.

16. The faucet locking mechanism of claim 13, wherein a spring is mounted within the locking sleeve, and the spring surrounds the sliding frame and interacts with the sliding frame.

17. A faucet assembly comprising:
a faucet body; and
the faucet locking mechanism of claim 13, an upper end of the connecting sleeve connected to the faucet body, and the locking sleeve positioned below the faucet body.

18. A faucet mounting structure comprising:
a mounting platform comprising:
a platform through hole, and
a bottom surface comprising a rigid gasket ring; and
the faucet assembly of claim 9, the faucet body positioned above the mounting platform.
